(19) United States
(12) Patent Application Publication
(10) Pub. No.: US 2002/0055856 A1
(43) Pub. Date: May 9, 2002

(54) Adjudicating pharmaceutical drug sample distribution system and method

(76) Inventor: William M. Adams, Halifax (CA)

Correspondence Address: ROBERT W STROZIER, PLLC, 2925 BRIARPARK, SUITE 930, HOUSTON, TX, 77042, US

(21) Appl. No.: 09/991,381

(22) Filed: Oct. 22, 2001

Related U.S. Application Data
(60) Provisional application No. 60/242,294, filed on Oct. 20, 2000.

(51) Int. Cl. G06F 17/60

(52) U.S. Cl. 705/2

(57) ABSTRACT

An improved system and method of pharmaceutical drug samples distribution replaces actual samples provided to physicians for re-distribution to patients. A token, preferably in the form of a partially completed script, is provided to physicians for delivery as a completed prescription to patients. The completed token is presented to pharmacists to obtain the drug sample. Before providing the sample, the token is adjudicated by a claim adjudication system. Token usage data may be compiled by the claim adjudication system and forwarded for use by pharmaceutical companies. Value-added services such as drug utilization review (DUR) may be provided by the claim adjudication system. Token usage data may be correlated with token distribution data to provide a measure of sampling program effectiveness, including pharmaceutical company representative performance.

### CROSS-REFERENCE TO RELATED APPLICATIONS

This application is related to and claims the benefit of U.S. Provisional Patent Application Serial No. 60/242,254 filed Oct. 20, 2000.

### TECHNICAL FIELD

The present invention relates to pharmaceutical drug sample distribution. In particular, it relates to an alternative to traditional clinical evaluation packages (i.e. trial samples) distributed by pharmaceutical manufacturers that utilizes adjudicating pharmacy dispensing and critical information tracking.

### BACKGROUND OF THE INVENTION

Distributing pharmaceutical drug samples is an integral and important practice for pharmaceutical marketing and patient care. Traditionally, pharmaceutical companies provide pharmaceutical clinical evaluation packages (i.e. trial samples) through their respective representatives to physicians or other authorized health care providers or institutions for distributing to patients. The trial sample permits the pharmaceutical representative to provide a transactional selling benefit within the representative/physician interaction and, of course, also permits a physician to see if the therapy selected is safe, tolerable and therapeutically effective. Moreover, sampling assists pharmaceutical representatives to gain access to physicians and promote the medication within its therapeutic indications.

Unfortunately, many samples expire on physicians' shelves, are misused, stolen or destroyed. Indeed, the practice of sampling today is potentially unsafe, costly and lacking in safeguard controls and effective evaluation (i.e. an ability to calculate return on investment). Numerous difficulties with typical sampling practices in Canada and the United States have been identified. Under current systems, samples are not consistently recorded in patient charts or other forms of record keeping. Policies concerning transport, storage, and sample use are not adhered to consistently. It is known that pharmaceutical companies routinely require their representatives to carry samples in their vehicles for distribution. However, leaving trial samples in the elevated temperatures of automobiles in the summer months, or in freezing temperatures in the winter is contrary to storage guidelines.

There are also many instances of sample abuse. In one published study on sample medication dispensing, investigators found that nearly one half of the samples in a physician's practice were dispensed to persons (e.g. physicians, their families, office staff, etc.) other than intended patients. It is likely that many instances of free sample use represent self-prescribing. For office staff, self-prescribing may represent prescribing without a license. The absence of a licensed healthcare practitioner to monitor medication and possible attendant adverse effects is a risk that physicians would not recommend for their patients and should not recommend for themselves or their staff.

The pharmaceutical market is highly dynamic with an influx of new drugs introduced each year that is apparently increasing at a rapid pace. As the number of new drugs being developed and launched increases, the number of samples is expected to increase, leading to an increase in misuse and patient risk. Moreover, as the population ages, the demand for pharmaceuticals is expected to further increase due to health complications associated with an aging population.

Currently most pharmacies utilize integrated computer systems to assist with day-to-day operation and management. For example, such computer systems provide pharmacy practice management for drug dispensing and inventory management, as well as automated pharmacy benefits claims management to facilitate real-time adjudication services for drug or other health claims. According to the National Council for Prescription Drug Programs, (“NCPDP”) a standards development organization for the pharmacy services sector of the health care industry, there are about 2.7 billion prescriptions filled each year in the United States. An estimated 80%, or about 2 billion prescriptions, are electronically submitted to pharmacy payers using one of the NCPDP telecommunication standards. Similar standards are implemented in Canada by the Canadian Pharmacists Association (“CPhA”).

Many patients have drug plan coverage offered by insurance companies, self-funded employers and others. A patient may make a claim under a respective plan through the patient's pharmacist at the time a prescription is filled. Pharmacists submit claims in real-time or batch mode to a claims adjudication network for adjudication processing. Typically, the electronic processing of such claims is managed by third parties on behalf of the pharmacy payers. These third party adjudicators have expertise in communications and information processing including electronic data interchange (EDI).

In addition to claims adjudication services, the adjudication network may provide other value-added pharmacy benefit management services, such as drug utilization review for assuring that a patient receives an appropriate drug therapy based on current medical guidelines. Additional pharmacy benefit management services may include an option that directs the use of recommended lower cost drugs that have the same or similar therapeutic effects and disease management (formulary management) or other managed care methods for a chronic or acute condition. Well-known pharmacy benefit managers and value-added network suppliers providing claims adjudication services are National Data Corporation (“NDCHealth”), EBRx, Inc., a division of Managed Care of America, Inc., and Express Scripts, Inc. including ESI Canada, among others.

Both the NCPDP and CPhA prescribe standards for the electronic communication of claims for adjudication. The claim standards may include protocols to facilitate additional pharmacy benefit management functions such as drug utilization review or to update patient address or other information with third party payers, etc. The standards have been developed to provide a simplified and common claim format for all parties to use for orderly and efficient online processing of prescription drug claims. In addition to defining standards for the data format and content of electronic claims, a transmission protocol and other telecommunication requirements are also defined (e.g. CPhA Asynchronous Communications Standard).

Data networks for facilitating communications among pharmacists and adjudicators are wide spread, some of which operate nationally in Canada and the United States.

Current pharmaceutical sampling systems have not capitalized on these new information processing capabilities. Alternative drug sample distribution systems have been proposed, for example, in U.S. Pat. No. 5,628,530, entitled, “Method and System for Collectively Tracking Demographics of Starter Drug Samples” of Thornton issued May 13, 1997 (“Thornton”) and (U.S. Pat. No. 5,832,449 entitled, “Method and System for Dispensing, Tracking and Managing Pharmaceutical Trial Products” of Cunningham issued Nov. 3, 1998 (“Cunningham”).

Thornton discloses a method and system for collectively tracking demographics of physician prescribed starter drug samples. The samples are dispensed to patients employing a multiple part product, specific sample drug voucher, such as a smart card or a pre-printed voucher. The voucher has a marketing information portion and a separable prescription portion for completion by the prescribing physician. The physician may specify the starter drug sample quantity and dosage information, patient demographic information and physician information. The prescription portion is segregated from the marketing information portion at the pharmacy and the prescription information therefrom is electronically retrievably stored in the pharmacy computer. From the pharmacy computer, the information is electronically transmitted to a central remote computer, such as at the drug manufacturer, for tracking use of the sample voucher and subsequent market analysis.

Thornton does not disclose a method or means for adjudicating the sample drug voucher to control its use or account to the pharmacy for drug sample product or dispensing services.

Cunningham teaches a method of dispensing, tracking and managing pharmaceutical product samples. Prescribers and pharmacies are communicatively linked to a central computing station. Sample drug product media is distributed to prescribers for giving to patients. Patients in turn exchange the media for actual pharmaceutical product at a pharmacy. The media is encoded with information that identifies a particular pharmaceutical trial product, such as by magnetic encoding similar to that used with credit cards. The media must be activated via the central computing station by participating medical doctors or prescribers prior to giving the media to patients. Before filling the pharmaceutical trial product identified by the media, the pharmacy validates the media via a link with the central computing station. Then, the pharmacy dispenses the prescribed pharmaceutical trial product. The central computing station also includes a database that records data related to the use of the media so that all pharmaceutical trial products can be accounted for.

While Cunningham discloses a method of activating and authenticating the drug sample media via a central computing station, the process is overly complicated and expensive, requiring physicians as well as pharmacies to have electronic computing equipment equipped with a reader/writer and adapted to communicate with the central station.

Neither Cunningham nor Thornton discloses adjudication of a sample drug claim via an adjudication network to capitalize on efficiencies gained from shared resources. Nor does either patent disclose adjudication services in association with pharmacy benefits management services such as DUR or other value-added services.

Moreover, neither Cunningham nor Thornton discloses a method or system for correlating drug sample product use data with other data for accessing the success of a sampling program.

What is therefore needed is a method and system that enables better data management and control of prescription sample medications, reduces, waste, improves patient safety, increases convenience, and provides an overall more effective approach to implementation.

There is also a need for a method and system that facilitates efficient gathering and dissemination of usage information in real-time to promote valuable insight into sample utilization, which can enhance pharmaceutical profitability.

### SUMMARY OF THE INVENTION

It is therefore an object of the invention to provide an adjudicated pharmaceutical drug sample distribution system and method.

In accordance with an aspect of the invention, there is provided a method for distributing pharmaceutical drug samples. The method comprises a step of adjudicating a claim by a drug dispenser for the use of a token for a pharmaceutical drug sample at a claim adjudication system for pharmacy benefit claims. In accordance with the method, the token is distributed by a prescriber to permit the patient to obtain the pharmaceutical drug sample from the drug dispenser.

The step of adjudicating may comprise steps of receiving at the claim adjudication system a request for adjudication in a first predefined format from the drug dispenser; and sending to the drug dispenser an adjudication response in the predefined format in response to the request for adjudication. Preferably, the steps of receiving and sending are performed in accordance with a protocol for electronic processing of pharmacy benefit claims. The steps of receiving and sending may be performed using a communications network for communications between a plurality of drug dispensers and a plurality of adjudicators for the electronic processing of pharmacy benefit claims.

The step of adjudicating may further comprise steps of receiving information about tokens that are distributed receiving information about the token from the drug dispenser; and processing the request to provide the adjudication response. The step of processing uses the information about tokens that were distributed, the information about the tokens from the drug dispenser, and business logic related to the token. Additionally, the step of adjudicating may further comprise a step of receiving information about the prescribers to which tokens were distributed and the information about the token received from the drug dispenser comprises prescriber information. The step of processing may then further comprise a step of comparing the information about the prescriber with the information about the prescriber to which tokens are distributed.

In accordance with further features of this aspect of the invention, the step of adjudicating further comprises steps of storing token usage data related to the token, and periodically providing the token usage data to enable evaluation of a pharmaceutical drug sample distribution program. The step of adjudicating may further comprises a step of providing value-added services.

The method may further comprise a step of entering information related to the token into a pharmacy benefit management system used for dispensing pharmaceutical drugs and for sending and receiving adjudication communications.

Additionally, the method may further comprise a step of distributing tokens for delivery to prescribers. Preferably, such a method further comprises a step of storing token distribution data related to the tokens where the token distribution data includes prescriber information to identify prescribers to whom the tokens were distributed. The method may yet further comprise steps of periodically receiving token usage data related to the token, the token usage data being generated and stored by the claim adjudication system; and correlating the token usage data with token distribution data.

According to this aspect of the invention, the method may further comprise a step of prescribing the pharmaceutical drug sample for a patient using the token. A step of accounting to the drug dispenser for the dispensing of the pharmaceutical drug sample may also be included in the method.

In accordance with a further aspect of the invention there is provided a computer readable medium containing executable program instructions for enabling a computer system to track distribution of pharmaceutical drug samples. The computer readable medium comprises program instructions executable by a claim adjudication system for pharmacy benefit claims to enable adjudication of a claim by a drug dispenser for a use of a token presented in return for a pharmaceutical drug sample. In accordance with this aspect, the token is distributed to a prescriber who provides the token for a patient to permit the patient to obtain the pharmaceutical drug sample from the drug dispenser.

Yet another aspect of the invention provides a computer readable medium containing executable program instructions for enabling a computer system to track a distribution of pharmaceutical drug samples. The computer readable medium comprises program instructions for entering adjudication information related to a token for a pharmaceutical drug sample into a pharmacy benefit management system for dispensing pharmaceutical drugs; and program instructions for enabling a drug dispenser to communicate with a claim adjudication system for pharmacy benefit claims to adjudicate a claim for a use of a token presented in return for a pharmaceutical drug sample. In accordance with this aspect, the token is distributed to a prescriber who provides the token for a patient to permit the patient to obtain the pharmaceutical drug sample from the drug dispenser.

A further aspect of the invention provides a computer readable medium containing executable program instructions for enabling a computer system track that distribution of pharmaceutical drug samples, comprising program instructions for periodically receiving token usage data from a claim adjudication system for pharmacy benefit claims that adjudicates a claim for a use of the token and stores token usage data; and program instructions for analyzing the token usage data.

Another aspect of the invention provides a computer system for tracking the distribution of pharmaceutical drug samples. The computer system comprises a claim adjudication system for pharmacy benefit claims including means for adjudicating a claim by a drug dispenser presented with a token for a pharmaceutical drug sample. In accordance with the aspect, the token is distributed to a prescriber who prescribes the pharmaceutical drug sample to a patient using the token whereby the dispensing of the pharmaceutical drug sample is tracked in response to the adjudication of the claim.

Another aspect provides, a pharmacy benefit management system to control the distribution of a pharmaceutical drug sample. The pharmacy benefit management system comprises a pharmacy benefit management database; means for entering adjudication information related to a token for a pharmaceutical drug sample into the pharmacy benefit management database; and means for communicating with a claim adjudication system for pharmacy benefit claims to adjudicate a claim for use of the token. Again, the token has been distributed to a prescriber who prescribed the pharmaceutical drug sample to a patient using the token which was presented to the drug dispenser to obtain the drug sample whereby the dispensing of the pharmaceutical drug sample is tracked in response to the adjudication of the claim.

In accordance with yet a further aspect, a computer system for analyzing the distribution of a pharmaceutical drug sample is provided. The computer system comprises means for periodically receiving token usage data from a claim adjudication system for pharmacy benefit claims, which adjudicates claims for use of the tokens and stores token usage data, the tokens being distributed to prescribers who prescribe the pharmaceutical drug samples to patients using the tokens for presenting the tokens to the drug dispensers to receive the drug samples; and means for analyzing the token usage data.

### BRIEF DESCRIPTION OF THE DRAWINGS

Further features and advantages of the present invention will become apparent from the following detailed description, taken in combination with the appended drawings, in which:

FIG. 1 is a block diagram illustrating an overview of the method in accordance with the invention;

FIGS. 2a and 2b are schematic illustrations of an exemplary drug sample token in the form of a printed card in accordance with the invention;

FIG. 3 is a block diagram of a system for adjudicating drug sample tokens in accordance with the invention, using a pharmacy benefits adjudication network;

FIG. 4 is a flow chart illustrating a preferred method of distributing and adjudicating drug sample tokens in accordance with the invention; and,

FIG. 5 is a flow chart illustrating a preferred method of distributing and adjudicating drug sample tokens in accordance with the invention.

Throughout the appended drawings, like features are identified by like reference numerals.

### DESCRIPTION OF THE INVENTION

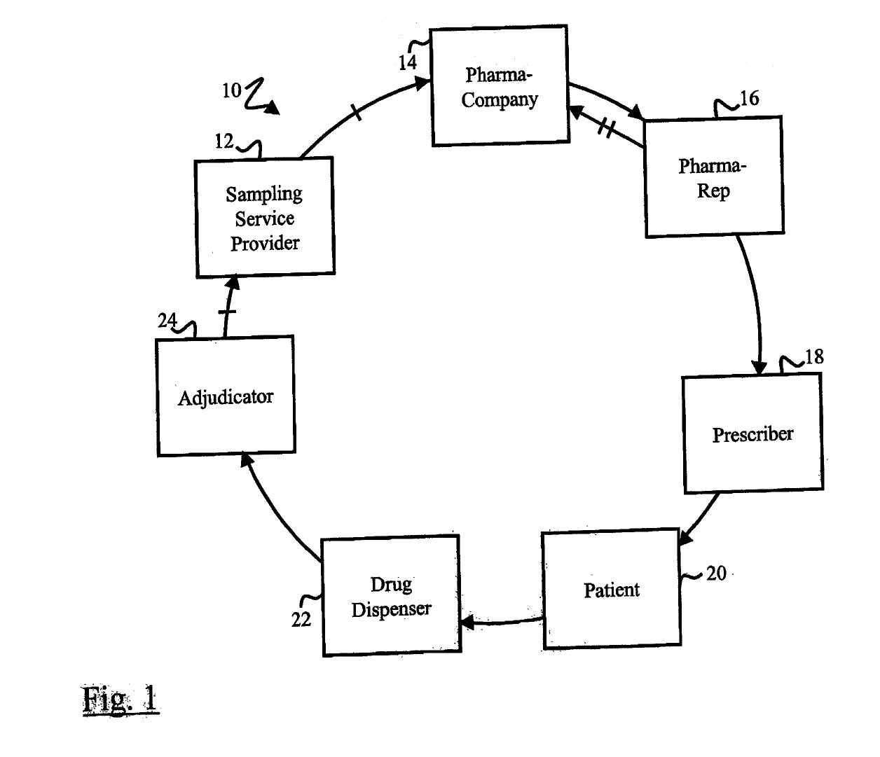

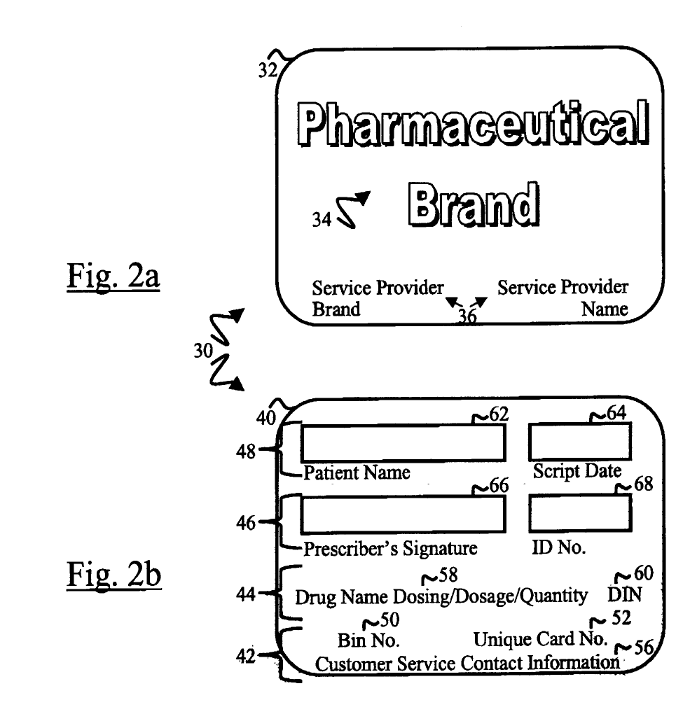

An overview of the presently preferred method of pharmaceutical drug sample distribution, including adjudicating drug sample tokens and collecting token usage data, is shown in FIG. 1. In accordance with the method, a drug sample token and distribution process 10 commences with an originator of the token, namely, sampling service provider 12. Sampling service provider 12 prepares drug sample tokens on behalf of a pharmaceutical company (pharma-company) 14 for distributing the pharma-company's drug samples. The drug samples have traditionally been distributed by a pharmaceutical representative (pharma-rep) 16 to a physician 18, and then to a patient 20. An exemplary token 30 in the form of a card is described below with reference to FIGS. 2a and 2b.

The sampling service provider 12 further coordinates the adjudication of tokens 30, data collection and pharmaceutical dispensing, typically involving an adjudicator 24 and a drug dispenser 22 (e.g. a pharmacist) who receives the token 30 from the patient 20. Tokens 30 flow among the participants from sampling service provider 12 through to drug dispenser 22, as illustrated in a generally clockwise direction by solid lines in FIG. 1. Token use data (illustrated by single hashed lines) is primarily collected by adjudicator 24 and flows to pharmaceutical company 14 through the sample service provider 12. Token distribution data may be compiled by the pharma-rep 16 and provided to the pharma-company 14 as illustrated by double hashed lines.

In accordance with an embodiment of the invention, the drug sample token 30 comprises a pre-printed card that may be used as a prescription (script) in accordance with any applicable law or regulation that may govern prescriptions and pharmaceutical drug advertisement material. With reference to FIGS. 2a and 2b, token 30 comprises a first side 32 and a second side 40. The first side 32 displays a pharmaceutical brand identifier 34 such as a trademark, in word and/or design form, for the drug sample to be obtained with the token 30, together with the sampling service provider's name and/or brand (collectively, 36) and/or pharmaceutical company name (not shown). Additionally the first side 32 may include other information, such as information related to the sample drug or notices concerning use of the token (not shown). Notices may include a, legal notice respecting issues of privacy law, notifying a token user that use of the card entails the collection of certain types of data. The notice may refer the token user to additional information source(s).

The second side 40 of token 30 may display pre-printed information concerning the drug sample to be obtained with the token and areas where additional information concerning the prescriber and patient may be added to complete the script. The second side 40 may display token processing information 42, drug information 44, space for recording prescriber information 46, and patient information 48. Token processing information 42 may include a bank identification number 50 (i.e. BIN #) or other code identifying a particular claim adjudication provider system, unique card identifier 52 and optionally, customer service contact information 56 such as a toll free contact number, Internet web page or, email address for adjudication assistance.

Drug information 44 may include a generic drug name, dosing, dosage, and quantity identification 58 and any required regulatory identifier 60 such as, in Canada, a drug identification number (i.e. DIN). Patient information 48 may include a patient name entry field 62 and a script date field 64, while prescriber information 46 may include a space for a prescriber's signature 66 and a unique physician identifier 68 (i.e. ID No.). ID No. 68 is typically a number (or alphanumeric or other code) issued to a prescriber 18 by a governing entity for licensing or regulating health care providers who are qualified to prescribe pharmaceuticals.

While the pre-printed token processing information 42 and drug information 44 are illustrated as alpha-numeric data, it will be understood by those skilled in the art that such information may be presented alternatively or additionally in a computer-readable form, such as with bar coded data or a magnetically encoded strip. In this embodiment, prescribers manually complete the prescriber information 46 and patient information 48 to avoid requiring prescribers to have electronic equipment to encode the tokens with such information.

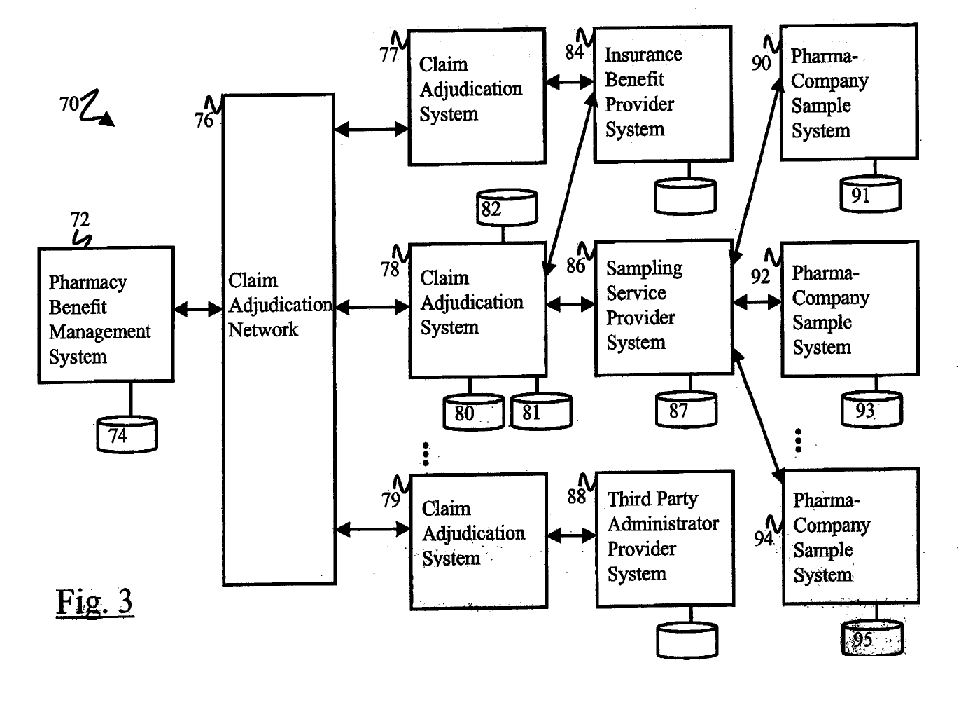

FIG. 3 illustrates an exemplary adjudication and data collection system 70 according to the invention. A pharmacy benefit management system 72, typically resident in a retail or other pharmacy includes one or more pharmacy databases 74 for receiving and storing information for dispensing prescriptions and adjudicating a claim against the patient's pharmacy benefit plan, if applicable. Pharmacy benefit management system 72 is connected to a claims adjudication network 76 for communication with one or more claim adjudication systems (77, 78 and 79). The connection to the network 76 may be made periodically (i.e. on demand) through the public switched telephone network (PSTN) or via a dedicated line, or other means.

The pharmacy benefit management system 72 may comprise a personal computer including software, hardware and firmware for operating a pharmacy dispensary, including automated pharmacy benefit claim adjudication, preferably in real-time, as is well known in the art. The pharmacy benefit management system 72 is further configured for automated pharmaceutical drug sample claims adjudication in accordance with the invention.

Claim adjudication network 76 is typically a packet, network for asynchronous communication of packet data among pharmacy benefit management system 72 and claim adjudication systems 77, 78 and 79. Such a network 76 is commercially available, as will be understood by those skilled in the art, through service providers such as National Data Corporation, and others, for handling pharmacy benefit claims. Such a network is similar in functionality to credit card and debit card processing networks commonly utilized at retail point of sale counters.

Claim adjudication systems 77, 78 and 79 are configured to adjudicate pharmacy benefit claims on behalf of one or more insurance benefit providers (84) third party administrators (88) and self-insuring employers, etc. (not shown). Exemplary claims adjudication system 78 is additionally configured to adjudicate pharmaceutical drug sample claims in accordance with the inventions. Specialist service providers known as pharmacy benefit managers typically operate claim adjudication systems. However, adjudication systems may be operated directly by third party administrators or insurance companies, among others.

Claims adjudication system 78 includes a drug sample adjudication database 80 for storing information related to the token such as token processing information 42, drug information 44, business rules for adjudicating the tokens 30, pricing information and token usage, data and a prescriber database 81 for storing information related to authorized prescribers. Preferably, there is also one or more health plan adjudication database(s) 82 for storing patient health plan information and adjudication rules. Any of claims adjudication systems 77, 78 and 79 may be connected for electronic communications with one or more insurance benefit provider systems 84, or third party administrator systems 88, for health benefit claim adjudication. Claims adjudication system 78 is further connected to sampling service provider system 86 in accordance with the invention.

Sampling service provider system 86 includes a token database 87 for storing information related to the token such as token processing information 42, drug information 44, business rules for adjudicating the token, pricing information, pharmaceutical brand name and token usage data, etc. Sampling service provider system 86 is connected to one or more pharma-company sample system 90, 92 and 94 each including a database 91, 93 and 95 respectively, for storing information related to the company's drug sample programs. Drug sample program information may include information related to the token such as token processing information 42, drug information 44, pharmaceutical brand name, etc. It may also include token usage data, summaries of meetings between representatives 16 and prescribers 18, including prescriber information 46 and token identifiers 52 for tokens 30 distributed to a prescriber 18.

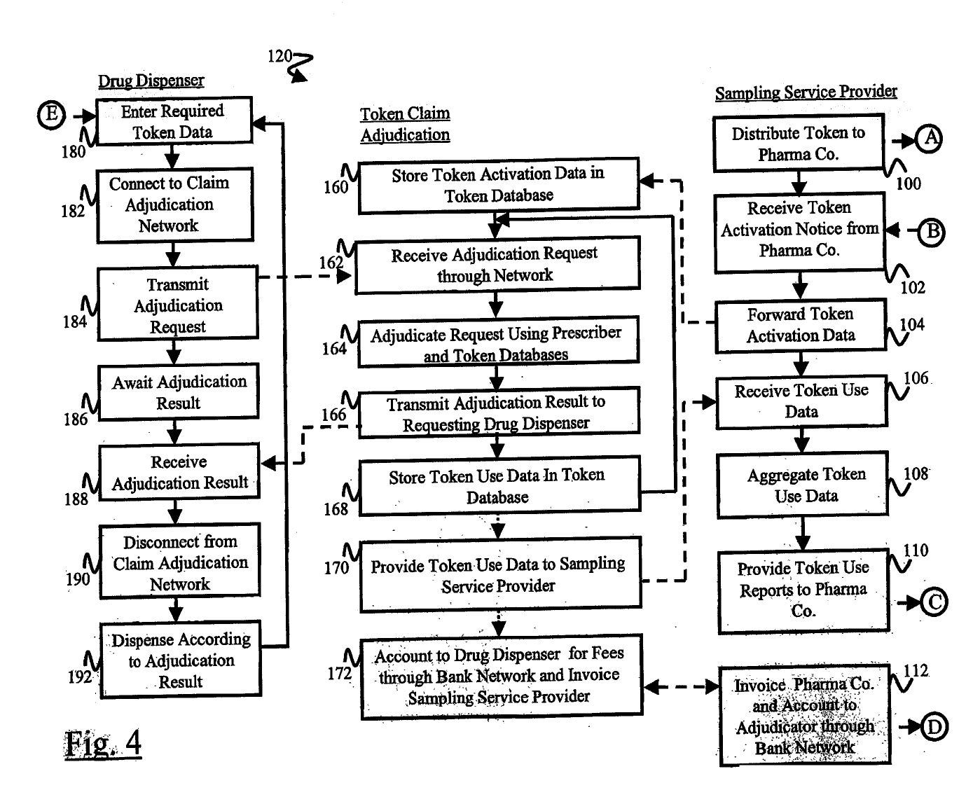

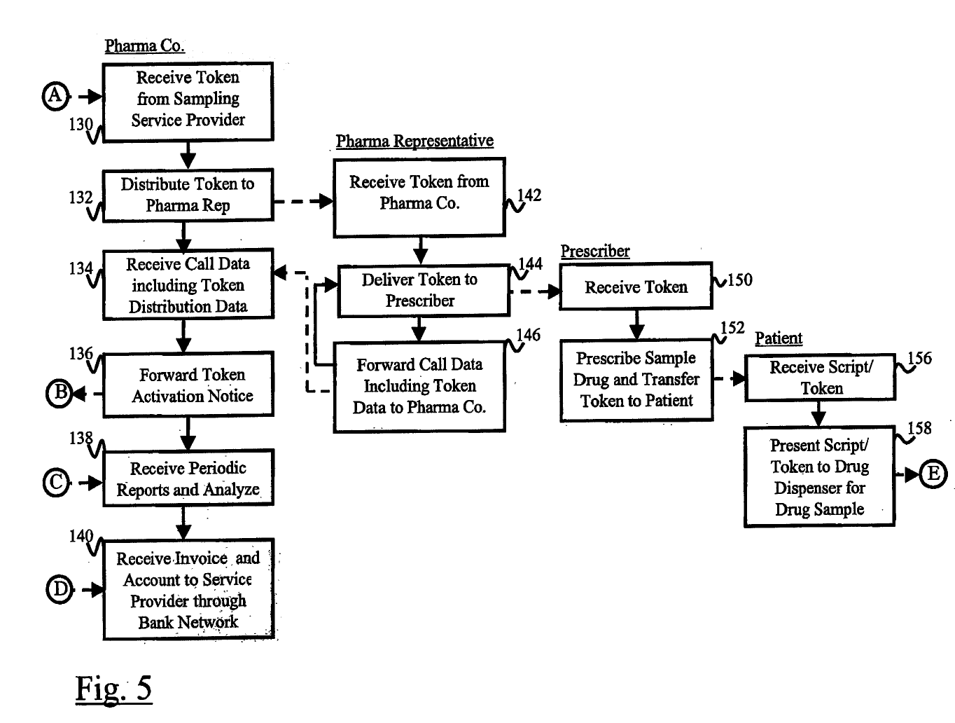

FIGS. 4 and 5, illustrate an embodiment of the method in accordance with the invention, as may be better understood with reference to FIG. 3. In step 100 of FIG. 4, sampling service provider 12 prepares and distributes a plurality of drug sample tokens 30 to pharmaceutical company 14. The token cards 30 are physically distributed and each single-use card 30, may be exchanged for a trial drug sample for the specific drug identified on the card. Token preparation information and token processing information 42 is stored in token database 87 of sampling service provider system 86.

Pharmaceutical company 14 receives the tokens 30 and token processing information for its database (e.g. 91) from sampling service provider 12 (step 130 of FIG. 5). The tokens 30 are distributed to its pharma-reps 16, and drug sample program database 91 is updated to note which cards 30 (by using the identifier 52) are given to which pharma-reps 16 for later correlation to token use data (step 132). Pharma-reps 16 receive the tokens 30 (step 142) and distribute the tokens 30 to prescribers 18. Distribution typically occurs during a call at the prescriber's office, at which time information concerning the drug to be sampled is normally discussed with the prescriber 18 (step 144). Journal-based or other literature concerning the drug may be discussed and/or provided to the prescriber 18 during the call. Following the call, pharma-reps 16 prepare a meeting summary for each prescriber 18 they visit and note which particular tokens (i.e. by unique identifier 52) were provided to the prescriber 18. It should be understood that software applications for managing a pharmaceutical representative's practice are widely employed and may be used for the distribution activity. In step 146 the meeting summary including token identifier 52 and prescriber information (ID No. 68) is forwarded to pharma-company 14, preferably by electronic means, to pharma-company sample system 90 for storage in database 91 to provide token distribution data for tokens delivered to prescribers to enable future analysis.

In order to adjudicate a claim for a use of the token 30, it is necessary to advise adjudicator 24 of the information related to at least those tokens 30 that have been distributed. Token processing information 42, drug information 44, pharmaceutical brand name, business logic for adjudicating the tokens and pricing information may be provided to adjudicator 24 when the tokens 30 are distributed to the pharmaceutical company 14 (not shown) or at a later time, preferably prior to distribution of tokens to patients 20. Should the tokens 30 be lost or stolen prior to distribution to prescribers 18, the tokens 30 cannot be exchanged for actual drugs, as they have yet been activated within the adjudicator's system. If token processing information 42 is provided to adjudicator 24 before the tokens 30 are delivered to prescribers 18, it is preferred that adjudication be denied until pharmaceutical company 14 sends a notification of the distribution of the tokens 30 to signal to adjudicator 24 that the tokens 30 are available to patients 20. Notification may be made upon distribution to the representatives 16 but is preferably made following step 134, once the representatives 16 deliver their respective tokens 30 to prescribers 18 and report same. Following receipt of the confirmation of the distribution of tokens 30 by pharmaceutical company 14, notification of same is electronically forwarded to sampling service provider 12 (step 136).

In steps 102 and 104 of FIG. 4, sampling service provider 12 receives notification of token distribution (i.e. token identifiers 52 provided adjudicator 24 has the other necessary information related to the token 30) and forwards token processing information 42 (or notification) electronically to adjudicator 24. In step 160, adjudicator 24 stores the token processing information 42 in drug sample adjudication database 80 to establish data for the distributed tokens 30 within its claim adjudication system 78.

In step 150 of FIG. 5, prescriber 18 receives tokens 30 from the representative 16. When a prescriber 18 desires to initiate a drug therapy for a patient 20 involving the drug that may be obtained with the token 30, prescriber 18 prescribes the therapy and gives the token 30 to the patient 20 (step 152). In this embodiment, token 30 is completed by hand by filing in the required patient information 46 and prescriber information 48. The token thus acts as a script for the sample drug.

In steps 156 and 158, patient 20 receives, token 30 and, in turn, presents token 30 to a pharmacy or other authorized drug dispenser 22 in exchange for the drug sample.

In step 180 (FIG. 4), in order to dispense the drug sample, drug dispenser 22 electronically enters information from the token 30 into the pharmacy benefit management system 72. In addition to typical prescription information (i.e. drug information 44, patient information 48 and prescriber information 46) drug dispenser 22 also enters token processing information 42 in a similar way that pharmacy benefit claim information may be entered for patients having a pharmacy benefit plan, (i.e. drug) coverage. Preferably, drug dispenser 22 also examines the physician's signature and makes a determination of its authenticity.

In accordance with a standard for claim adjudication systems processing established by the Canadian Pharmacy Association (CPhA) BIN No. 50 of the token 30 identifies which claim adjudication system (e.g. 78) from a plurality of claim adjudication systems (e.g. 77, 78 and 79) accessible via the claim adjudication network 76 is to be used to process the claim. BIN No. 50, or an additional identifier (e.g. a Carrier No.), may be provided on token 30 to further identify the appropriate sampling service provider (e.g. 12) associated with the token to assist adjudicator 24 in adjudicating the token 30. Following the entry of the information, the pharmacy benefit management system 72 connects with the claim adjudication network 76, (step 182) for communication with the claim adjudication system 78 of adjudicator 24 identified by. BIN No. 50. A request for adjudication is transmitted by drug dispenser 22 to the adjudicator 24(step 184) and the drug dispenser awaits the adjudication response (step 186). The pharmacy benefit management system 72 may be in constant connection to the claims adjudication network 76, thus avoiding step 182.

In step 162 of FIG. 4, adjudicator 24 receives the request via network 76 at its claims adjudication system 78 and adjudicates the request. The adjudication of a claim proceeds according to the business logic established within claim adjudication system 78, which logic may be stored in drug sample adjudication database 80. The business logic defines how information related to the token obtained from the adjudication request formatted and sent by the pharmacy benefit management system 72 is validated against information related to the token processing from its drug sample adjudication database 80 and prescriber information (i.e. particularly ID No. 68) from a prescriber database 81 of authorized prescribers. Adjudication includes the steps of receiving the request and comparing the received information against corresponding information in the adjudication databases according, to the business logic. If the received information does not correlate with the stored information, adjudication is refused. If the received data does correlate, adjudication is allowed. In any event, the pharmacist is notified. Preferably, notification includes a reason (e.g. a code) for refusal, if applicable. In this manner, dispensing of the pharmaceutical drug sample is controlled.

While patient name 62 is not strictly necessary for adjudication, it may be provided as an additional element to check against an adjudicator's health plan adjudication database 82 or sample adjudication database 81. If the same patient 20 previously received the same sample drug, a further sample may be denied in some instanced. Or, the adjudicator may offer drug utilization review (DUR) services or other value-added services known to those skilled in the art, to monitor a patient's drug therapies for potential problems such as drug interactions, duplicate therapies, early refills or allergies, etc. The pharmacist could receive an indication of a potential complication in the adjudication response message for follow-up with the patient 20 or prescriber 18. In order to facilitate DUR, claim adjudication system 78 requires a patient's current drug therapy information, such as may be available in a health plan database 82.

In steps 166 and 188 of FIG. 4, the adjudication result is transmitted and received. Pharmacy benefit management system 72 may disconnect from the claims adjudication network 76 as may be applicable (step 190) and drug dispenser 22 dispenses the drug in accordance with the adjudication result (step 192). If the pharmacist receives an approval, the patient is given the sample medication and appropriate counseling on adverse effects and potential drug/drug interactions, in accordance with pharmacy practice. An electronic record of the adjudicated dispensing may be recorded in the patient's profile within the pharmacy's database 74. Though not shown, the pharmacist may retain token 30 for a period of time as a means of proof if audited by adjudicator 24, sampling service provider 12, or if required by law relating to prescriptions. The token may be returned to sampling service provider 12 or destroyed, if permissible.

In step 168, adjudicator 24 stores token usage data in database S0. The token usage data preferably includes: unique token ID No. 52; drug information 44 as well as the pharmaceutical brand name 34, physician name 66, an identifier associated with the pharmacy (e.g. a ZIP or postal code), as well as the date and time of the adjudication. Adjudicator 24 provides token usage data to sampling service provider 12 at least periodically (step 170), preferably by electronic transfer between claim adjudication system 78 and sample service provider system 86. Moreover, adjudicator 24 accounts to the drug dispenser 22 for product fees and dispensing fees at least periodically and preferably through an electronic funds transfer (EFT) via a bank network (not shown in FIG. 3). Adjudicator 24 also invoices sampling service provider 12 (step 172). Though not shown, adjudicators 24 commonly audit pharmacists for claims compliance to ensure that drugs for which claims have been made have actual been dispensed.

In steps 106 and 108 of FIG. 4, sampling service provider 12 receives the token usage data and stores it with related data in token database 87. Any patient identifying data is preferably removed prior to transmission of the token use data to sampling service provider 12 to avoid privacy concerns. In step 110, sampling service provider 12 prepares and provides token usage reports, at least periodically, to pharma-company 14. The reports are received and analyzed in step 138 of FIG. 5. Preferably the reports are provided electronically between sample service provider system 86 and pharma-company system 90.

Evaluation of a pharmaceutical drug sample program may be made by analyzing token usage data on its own or, preferably, in conjunction with token distribution data provided, in part, by pharma-reps 16. Pharma-company 14 may determine a measure of the effectiveness of its sampling programs, associating rates of use with particular prescribers 18 and pharma-reps 16. Analysis of particular sales techniques may also be made by correlating usage rates with prescriber/pharma-rep call data, which indicates how the sample tokens and appropriate therapies were presented to individual physicians.

Token usage data may be aggregated and pre-formatted into customized reports made available at periodic intervals or upon demand. General token usage statistics may also be compiled, calculating industry rates or individual pharma-company rates of token usage on a local, regional or national basis and against which individual sampling programs may be measured.

In step 112, the sampling service provider accounts to the adjudicator 24 and invoices pharmaceutical company 14 which in turn accounts to sampling service provider 12 at step 140 (FIG. 5).

The method and system in accordance with the invention address pharmaceutical industry concerns related to:

Patient Safety

Product branding and imaging

Representatives having access to physicians

Quality control and utilization control

Utilization information and physician usage data

Flexibility and cost savings

Product selection

Low prices

Support services

Ease of use

Lack of Measurable ROI with Samples

Rising Costs of Samples and Packaging

The method and system provide patients with improved safety and health care provider interaction and service by including the pharmacist in the sample medication dispensing process.

Detailed tracking of several key pieces of information including when and where the token is used in real-time is achieved. This provides a much more accurate measure of productivity for pharmaceutical representatives than is provided by company databases. This new measure of return on investment provides an added benefit to the pharmaceutical industry.

The gathering, organization and dissemination of information in real-time provides a capability to change the way that drug samples are used, and the amount of information that the samples generate. By adjudicating token use and aggregating token usage data through a claim adjudication system, the invention permits pharmaceutical companies to control inventory, improve product tracking, monitor and manage staff performance, and improve effectiveness of new drug launches.

As will be appreciated by those skilled in the art, the present invention provides many benefits over traditional methods of drug sample distribution.

Patients benefit from reduced risk of inappropriate or unsafe use of drug samples. The risk of drug/drug interactions is reduced by having another health care provider (pharmacist) involved in the sampling process. As well, sample dispensing directly to patients is ensured. Regulations respecting the pharmaceutical industry can also be more closely followed, to help ensure adherence to all legal responsibilities.

Pharmaceutical companies benefit from the measurable return on investment, real time data, cost savings, control, and information benefits associated with implementation of the method and system. The compliance regulations and other legal obligations are facilitated.

Physicians benefit from the reduced risk of inappropriate sample use by non-intended users. Physicians will no longer have to provide space for storing samples, and will no longer have to consider whether samples have expired, or may have lost stability, integrity for effectiveness. They will also benefit from the reduced chance of a patient having a life-threatening drug/drug interaction by having another health care provider involved in the drug sample distribution process. Removing the medication sample, and associated potential for misuse and abuse, from the physician's office reduces potential liabilities.

Pharmacies benefit from the system because the proper control of dispensing drugs is returned to the pharmacist. Pharmacists are the health professionals with the most training in the drug-dispensing field, and have long been eager to eliminate the uncontrolled and inefficient practice of drug sample dispensing. In accordance with the invention, they are compensated for each sample they dispense, and may receive a dispensing fee. Thus, their revenues should increase as a direct result. Intervention by the pharmacists also provides additional safety and cognitive services that ultimately benefits patients, providers and payers.

Adjudicators such as pharmacy benefit managers also benefit. In exchange for their expertise and infrastructure, a transaction fee is provided to them for their services. The adjudicators also benefit from a closer relationship with the pharmaceutical industry.

It will be understood by those skilled in the art that many modifications may be made to the preferred embodiments of the invention without departing from their scope. For example, though the system and method describe a sampling service provider for managing the sampling program, it is contemplated that a pharmaceutical company may manage its own sampling program, prepare its own tokens and co-ordinate adjudication, payment and data collection services with an adjudicator.

Furthermore, while the pharmacy benefit management system communicates with a claim adjudication system indirectly and in real-time via a shared claim adjudication network, the systems may communicate in alternate ways. For example, the systems may communicate in a time-delayed manner, such as in a batch mode, for adjudicating one or more claims. Moreover, the connection between the systems may be made individually such as via a direct line of communication.

The token can have any desirable format. It may be part of a pad of pre-printed scripts, an electronic smart card, magnetic card, or the like. The token may also include information related to more than one type of drug, dosing, dosage or quantity of sample drug(s), including repeats. Tokens may also be configured with expire dates or other sampling program control mechanisms. Token processing data may also be provided to prescribers for incorporation into the prescribers' regular scripts. It may be understood by persons skilled in the art that, as such, tokens may take an electronic form and be provided electronically to prescribers. Further, a prescriber may incorporate token processing data and any required prescriber data into a written, printed or electronic script. In accordance with a protocol for the electronic transmission of scripts between physicians and drug dispensers, token processing data may be electronically transmitted from a prescriber on behalf of a patient to a drug dispenser.

In addition to token usage data related to a token that may be generated by a particular claim for adjudication, additional data available to a claim adjudication system may be linked to the use of a particular token. Such further token usage data may be gathered and forwarded in association with token processing data for a particular token for analysis as discussed above. Claim adjudication systems may have access to pharmacy benefits data (e.g. in a database such as database 82) of patients who have also used tokens (which token usage data is available from database 80). Pharmacy benefits data may include prescription data for follow-up drug therapies for the same drug obtained with a token. Subsequent prescription data may be linked to use of the drug sample and provide a measure of the effectiveness of a pharmaceutical drug sample distribution program. A claim adjudication system may be configured to cross-reference pharmacy benefits data and token usage data for a patient and provide portions of the pharmacy benefits data which suggests a link to the use of the sample drug.

As previously discussed, one value-added service provided by pharmacy benefit managers is formulary management. Formulary management may direct the use of a drug that is typically lower in cost than other equivalent therapies to manage the costs of a pharmacy benefit plan provided by a private or public (e.g. government) payer. In accordance with the present invention, formulary management techniques may be used to limit the availability of coverage for certain drug therapies under a pharmacy benefit plan unless the patient has completed a drug sample therapy. The claim adjudication system may cross-references pharmacy benefit data with token usage data for a patient to confirm a prior drug sample therapy.

The embodiment(s) of the invention described above are intended to be exemplary only. It is therefore intended that the scope of the invention be limited solely by the scope of the appended claims.

I/we claim:

1. A method for distributing pharmaceutical drug samples, comprising a step of
adjudicating a claim by a drug dispenser for the use of a token for a pharmaceutical drug sample at a claim adjudication system for pharmacy benefit claims, the token being distributed by a prescriber to permit the patient to obtain the pharmaceutical drug sample from the drug dispenser.

2. The method as claimed in claim 1 wherein the step of adjudicating comprises steps of:
receiving at the claim adjudication system a request for adjudication in a first predefined format from the drug dispenser; and
sending to the drug dispenser an adjudication response in the predefined format in response to the request for adjudication.

3. The method as claimed in claim 2 wherein the steps of receiving and sending are performed in accordance with a protocol for electronic processing of pharmacy benefit claims.

4. The method as claimed in claim 2 wherein the steps of receiving and sending are performed using a communications network for communications between a plurality of drug dispensers and a plurality of adjudicators for the electronic processing of pharmacy benefit claims.

5. The method as claimed in claim 2 wherein the step of adjudicating further comprises steps of:
receiving information about tokens that are distributed;
receiving information about the token from the drug dispenser; and
processing the request to provide the adjudication response using the information about tokens that were distributed, the information about the tokens from the drug dispenser, and business logic related to the token.

6. The method as claimed in claim 5 wherein the step of adjudicating further comprises a step of receiving information about the prescribers to which tokens were distributed, wherein the information about the token received from the drug dispenser comprises prescriber information, and the step of processing further comprises a step of comparing the information about the prescriber with the information about the prescriber to which tokens are distributed.

7. The method as claimed in claim 1 wherein the step of adjudicating further comprises steps of storing token usage data related to the token, and periodically providing the token usage data to enable evaluation of a pharmaceutical drug sample distribution program.

8. The method as claimed in claim 1 wherein the step of adjudicating further comprises a step of providing value-added services.

9. The method as claimed in claim 1 further comprising a step of entering information related to the token into a pharmacy benefit management system used for dispensing pharmaceutical drugs and for sending and receiving adjudication communications.

10. The method as claimed in claim 1 further comprising a step of distributing tokens for delivery to prescribers.

11. The method as claimed in claim 10 further comprising a step of storing token distribution data related to the tokens, the token distribution data including prescriber information to identify prescriber to whom the tokens were distributed.

12. The method as claimed in claim 11 further comprising steps of:
periodically receiving token usage data related to the token, the token usage data being generated and stored by the claim adjudication system; and
correlating the token usage data with token distribution data.

13. The method as claimed in claim 1 further comprising a step of prescribing the pharmaceutical drug sample for a patient using the token.

14. The method as claimed in claim 1 further comprises a step of accounting to the drug dispenser for the dispensing of the pharmaceutical drug sample.

15. A computer readable medium containing executable program instructions for enabling a computer system to track distribution of pharmaceutical drug samples, comprising:
program instructions executable by a claim adjudication system for pharmacy benefit claims to enable adjudication of a claim by a drug dispenser for a use of a token presented in return for a pharmaceutical drug sample, the token having been distributed to a prescriber who provided the token for a patient to permit the patient to obtain the pharmaceutical drug sample from the drug dispenser.

16. The computer readable medium as claimed in claim 15 wherein the program instructions further comprise:
program instructions for receiving a request for adjudication in a predefined format from the drug dispenser; and
program instructions for sending an adjudication response in a predefined format to the drug dispenser.

17. The computer readable medium as claimed in claim 16 wherein the program instructions for receiving and the program instructions for sending further comprise:
program instructions for using a communications network for communications between a plurality of drug dispensers and a plurality of adjudicators for the electronic processing of pharmacy benefit claims.

18. The computer readable medium as claimed in claim 16 wherein the program instructions further comprise:
program instructions for receiving and storing information about tokens that were distributed;
program instructions for receiving and storing information about the token presented to the drug dispenser; and
program instructions for processing the request to provide the adjudication response using the information distributed about the tokens, the information about the token presented and business logic related to approved use of the tokens.

19. The computer readable, medium as claimed in claim 18 wherein the program instructions for adjudicating further comprise:
program instructions for receiving and storing information about prescribers to whom tokens were distributed; and
program instructions for comparing the information about the prescribers to whom tokens were distributed with information about a prescriber contained in the information about the token presented to the dispenser.

20. The computer readable medium as claimed in claim 15 wherein the program instructions further comprise:
program instructions for storing token usage data related to the token; and
program instructions for periodically communicating the token usage data to an analysis system to enable analysis of a pharmaceutical drug sample distribution program.

21. The computer readable medium as claimed in claim 15 wherein the program instructions further comprise program instructions for assisting in the provision of value-added services.

22. A computer readable medium containing executable program instructions for enabling a computer system to track a distribution of pharmaceutical drug samples, comprising:
program instructions for entering adjudication information related to a token for a pharmaceutical drug sample into a pharmacy benefit management system for dispensing pharmaceutical drugs; and
program instructions for enabling a drug dispenser to communicate with a claim adjudication system for pharmacy benefit claims to adjudicate a claim for a use of a token presented in return for a pharmaceutical drug sample, the token having been distributed to a prescriber who provided a token for a patient to permit the patient to obtain the pharmaceutical drug sample from the drug dispenser.

23. The computer readable medium as claimed in claim 22 wherein the communications with the claim adjudication system is conducted in accordance with a protocol for electronic processing of pharmacy benefit claims.

24. The computer readable medium as claimed in claim 22 wherein the program instructions comprise:
program instructions for using a communications network for communications between a plurality of drug dispensers and a plurality of adjudicators for the electronic processing of pharmacy benefit claims.

25. A computer readable medium containing executable program instructions for enabling a computer system to track the distribution of pharmaceutical drug samples, comprising:
program instructions for periodically receiving token usage data from a claim adjudication system for pharmacy benefit claims that adjudicates a claim for a use of the token and stores token usage data; and
program instructions for analyzing the token usage data.

26. The computer readable medium as claimed in claim 25 further comprising:
program instructions for storing token distribution data, the token distribution data including information about prescribers to whom the tokens were distributed; and
program instructions for correlating the token usage data with token distribution data.

27. A computer system for tracking the distribution of pharmaceutical drug samples, comprising:
a claim adjudication system for pharmacy benefit claims including means for adjudicating a claim by a drug dispenser presented with a token for a pharmaceutical drug sample, the token having been distributed to a prescriber who prescribed the pharmaceutical drug sample to a patient using the token;
whereby the dispensing of the pharmaceutical drug sample is tracked in, response to the adjudication of the claim.

28. The computer system as claimed in claim 27 wherein the means for adjudicating comprises:
means for receiving a message in a predetermined protocol from the drug dispenser requesting adjudication; and
means for sending an adjudication response message that conforms to the predetermined protocol to the drug dispenser;
wherein the predetermined protocol is a protocol for electronic processing of pharmacy benefit claims.

29. The computer system as claimed in claim 28 wherein the means for receiving request messages and the means for sending response messages each comprises means for communicating via a communications network with a plurality of drug dispensers for the electronic processing of pharmacy benefit claims.

30. The computer system as claimed in claim 27 wherein the means for adjudicating further comprises:
means for receiving information about tokens distributed to prescribers;
means for receiving information about the token presented to the drug dispenser; and
means for processing the request message to provide the adjudication response using the information about the tokens distributed to prescribers, the information about the tokens persecuted to the drug dispenser, and business logic related to that approved use of the tokens.

31. The computer system as claimed in claim 30 wherein the information about the token presented to the drug dispenser includes information that identifies the prescriber who prescribed the pharmaceutical drug sample, and the means for processing further comprises means for comparing the information that identifies the prescriber with the information about prescribers to whom the tokens were distributed.

32. The computer system as claimed in claim 27 wherein the means for adjudicating further comprises:
means for storing token usage data related to the tokens; and
means for periodically providing the token usage data to a pharmaceutical drug sample distribution program for analysis.

33. The computer system as claimed in claim 27 wherein the means for adjudicating further comprises means for facilitating the provision of value-added services.

34. A pharmacy benefit management system to control the distribution of a pharmaceutical drug sample, comprising:
a pharmacy benefit management database;
means for entering adjudication information related to a token for a pharmaceutical drug sample into the pharmacy benefit management database; and
means for communicating with a claim adjudication system for pharmacy benefit claims to adjudicate a claim for use of the token, the token having been distributed to a prescriber who prescribed the pharmaceutical drug sample to a patient using the token which was presented to the drug dispenser to obtain the drug sample;
whereby the dispensing of the pharmaceutical drug sample is tracked in response to the adjudication of the claim.

35. The computer system as claimed in claim 34 wherein the means for communicating is configured to operate in accordance with a protocol for electronic processing of pharmacy benefit claims.

36. The computer system as claimed in claim 34 wherein the means for communicating is configured for using a communications network for communications with a plurality of adjudicators for the electronic processing of pharmacy benefit claims.

37. A computer system for analyzing the distribution of a pharmaceutical drug sample, comprising:
means for periodically receiving token usage data from a claim adjudication system for pharmacy benefit claims, which adjudicates claims for use of the tokens and stores token usage data, the tokens being distributed to prescribers who prescribe the pharmaceutical drug samples to patients using the tokens for presenting the tokens to the drug dispensers to receive the drug samples; and
means for analyzing the token usage data.

38. The computer system as claimed in claim 37 further comprising:
means for receiving token distribution data for the token, the token distribution data including information about the prescribers to whom the tokens were distributed; and
means for analyzing the token usage data and token distribution data.
